(19) United States
(12) Patent Application Publication
(10) Pub. No.: US 2011/0019064 A1
(43) Pub. Date: Jan. 27, 2011

(54) TWO-DIMENSIONAL ARRAY OF RADIATION SPOTS FOR AN OPTICAL SCANNING DEVICE

(75) Inventor: Sjoerd Stallinga, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/933,166

(22) PCT Filed: Mar. 16, 2009
(86) PCT No.: PCT/IB2009/051069

§ 371 Date: Sep. 17, 2010

(30) Foreign Application Priority Data
Mar. 20, 2008 (EP) 08305063.3

(51) Int. Cl. H04N 5/225; G02B 21/06

(52) U.S. Cl. 348/340; 359/385; 348/E05.024

(57) ABSTRACT

The invention relates to an optical scanning device (10) comprising: a spot generator (20) for generating a two-dimensional array (8) of radiation spots at lattice points Pₘₙ=mT₁+nT₂ (m=1 to L₁, n=1 to L₂) where T 1 is a first lattice vector and T₂ is a second lattice vector, and scanning means for scanning a sample (26) through the array of radiation spots in a scanning direction such that the radiation spots trace essentially equidistant lines (81, 82, 83) relative to the sample. According to the invention, the angle γ between the scanning direction and the first lattice vector T₁ is at most as large as the angle between the scanning direction and the second lattice vector T₂, and the ratio L₁/L₂ is less than 0.6. According to a preferred embodiment, L₁ differs from Λ by less then 1.0 or L₁ equals Λ with a tolerance of 10% or, Λ being defined by √2 D/R=(1+Λ²) Λ, D being the length of a lattice diagonal and R being the resolution. The invention further relates to an optical scanning method.

### FIELD OF THE INVENTION

The invention relates to an optical scanning device comprising:
a spot generator for generating a two-dimensional array of radiation spots at lattice points

Pₘₙ=mT₁+nT₂ (m=1 to L₁, n=1 to L₂)
where T₁ is a first lattice vector and T₂ is a second lattice vector; and
scanning means for scanning a sample through the array of radiation spots in a scanning direction such that the radiation spots trace essentially equidistant lines relative to the sample.
   The invention further relates to an optical scanning method comprising the steps of:
generating a two-dimensional array of radiation spots at lattice points

Pₘₙ=mT₁+nT₂ where (m=1 to L₁, n=1 to L₂)
where T₁ is a first lattice vector and T₂ is a second lattice vector; and
scanning a sample through the array of radiation spots in a scanning direction such that the radiation spots trace essentially equidistant lines relative to the sample.

### BACKGROUND OF THE INVENTION

Optical scanning microscopy is a well-established technique for providing high resolution images of microscopic samples. According to this technique, one or several distinct, high-intensity radiation spots are generated in the sample. Since the sample modulates the radiation of the radiation spot, detecting and analyzing the radiation coming from the radiation spot yields information about the sample at that radiation spot. A full two-dimensional or three-dimensional image of the sample is obtained by scanning the relative position of the sample with respect to the radiation spots. The technique finds applications in the fields of life sciences (inspection and investigation of biological specimens), digital pathology (pathology using digitized images of microscopy slides), automated image based diagnostics (e.g. for cervical cancer, malaria, tuberculosis), and industrial metrology.

A radiation spot generated in the sample may be imaged from any direction, by collecting radiation that leaves the radiation spot in that direction. In particular, the radiation spot may be imaged in transmission, that is, by detecting radiation on the far side of the sample. Alternatively, a radiation spot may be imaged in reflection, that is, by detecting radiation on the near side of the sample. In the technique of confocal scanning microscopy, the radiation spot is customarily imaged in reflection via the optics generating the radiation spot, i.e. via the spot generator.

U.S. Pat. No. 6,248,988 proposes a multispot scanning optical microscope featuring a two-dimensional array of multiple separate focussed light spots illuminating the object and a corresponding array detector detecting light from the object for each separate spot. Scanning the relative positions of the array and object at slight angles to the rows of the spots then allows an entire field of the object to be successively illuminated and imaged in a swath of pixels. Thereby the scanning speed is considerably increased.

The array of radiation spots required for this purpose is usually generated from a collimated beam of light that is suitably modulated by a spot generator so as to form the radiation spots at a certain distance from the spot generator. According to the state of the art, the spot generator is either of the refractive or of the diffractive type. Refractive spot generators include lens systems such as micro lens arrays, whereas diffractive spot generators include phase structures such as the binary phase structure proposed in WO2006/035393.

The detector on which the array of radiation spots is imaged generally has an aspect ratio which does not differ substantially from one. In other words, the sensitive area is typically more or less quadratic. Off-the shelf image sensors typically have an aspect ratio of 3:4 or 4:5, which is suitable for viewing images on conventional displays. The use of off-the-shelf components is preferred from the point of view of cost. Furthermore, in order to maximize use of the sensitive area of the image sensor, the aspect ratio of the array of radiation spots is generally chosen to match the aspect ratio of the image sensor.

It is an object of the present invention to provide means and methods for optically scanning a sample using a two dimensional array of spots, wherein the throughput is increased as compared to the state of the art.

### SUMMARY OF THE INVENTION

According to the invention, the angle γ between the scanning direction and the first lattice vector T₁ is at most as large as the angle between the scanning direction and the second lattice vector T₂, and the ratio L₁/L₂ is less than 0.6. Of the two lattice vectors, T₁ is thus the one that is more aligned to the scanning direction than the other one. As is shown the Appendix B, the aspect ratio μ=L₁/L₂ being less or equal √⅓≈0.6 is a necessary condition for the throughput of the scanning device to be maximum for a given frame rate of the photodetector and a given extension and resolution of the array. Although this specific value has been derived for an array having square unit cells (see the Appendix B) it can also be advantageously applied to the case of an array having a hexagonal unit cell, the latter being very similar to an array having a square unit cell due to the fact that for both array types the lattice vectors T₁ and T₂ have the same magnitude (that is, |T₁|=|T₂|) and define an angle of comparable magnitude. In the case of a square unit cell T₁ and T₂ define a right angle while in the case of a hexagonal unit cell T₁ and T₂ define an angle of 60°. The extension D (length of the longer diagonal of the array) is usually determined by the available field of view of the collection optical system, i.e. the optical system collecting the spot array after it has interacted with the sample. For a given value of the extension D and a given resolution R, the aspect ratio μ=L₁/L₂ and the number L₁ are not independent (see again Appendix B). Thus the condition μ<0.6 implicitly sets an upper bound for L₁. As is seen from Appendix A, the alignment tolerance of the array is thereby improved. The range L₁/L₂<0.6 is also preferred for the reason that the throughput is increased with respect to the prior art assuming that the minimum read-out period (the inverse of the frame rate) required for detecting the radiation spots (using, e.g., a pixelated image sensor) is proportional to the size of the image of the array of light spots. These aspects are further elucidated in Appendices A and B. The notations (Lₓ, L_{y}) and (L₁, L₂) are used synonymously in this application. The notation (Lₓ, L_{y}) is generally used when referring to an array having a square unit cell.

The ratio L₁/L₂ may be less than 0.4. In fact, for a sufficiently large value of β=2D/R and a given frame rate F, maximizing the throughput requires L₁/L₂<0.4.

The ratio L₁/L₂ may be less than 0.2. In fact, for a sufficiently large value of β=2D/R and a given frame rate F, maximizing the throughput requires L₁/L₂<0.2.

The value L₁ may advantageously be 2, 3, or 4. These values are advantageous if the sensitive area of a detector for imaging the array of radiation spots is matched to the size of the array, assuming that the frame rate of the detector is inversely proportional to the size of the sensitive area. Furthermore, alignment tolerances are particularly large for these values of L₁.

According to a preferred embodiment, the product L₁L₂ is maximum or the area of the lattice unit cell is minimum, with a tolerance of 10%, under the constraint that the shape of the unit cell, the resolution, and the length of a lattice diagonal are fixed. Thereby the throughput of the scanning device is maximized, assuming either that the frame rate of the detector is given or that the frame rate is inversely proportional to the size of the area of radiation spots.

The unit cell of the lattice is preferably a square or a hexagon. A lattice having a square unit cell is particularly simple to implement. A lattice having a hexagonal lattice cell allows for closest packing of radiation spots, thereby maximizing the number of radiation spots per area.

According to a preferred embodiment, L₁ differs from Λ by less then 1.0 or L₁ equals Λ with a tolerance of 10%, Λ being defined by

\sqrt{2}D/R=(1+Λ²)Λ,

D being the length of a lattice diagonal and R being the resolution. Thereby the throughput is optimized for any given detector having a fixed frame rate, as shown in Appendix B.

Preferably the optical scanning device further comprises a detector and imaging optics for generating an optical image of the array of radiation spots on the detector. More preferably, the detector is a pixelated image sensor.

Preferably the detector has an essentially circular field of view and the image of a lattice diagonal measures between 0.9 and 1.0 times the diameter of the field of view of the detector. Thus the image of the array of radiation spots fits comfortably into the field of view.

The detector may have a sensitive area having an aspect ratio between 3:4 and 4:3. Such detectors are readily available and provide an economic solution although the aspect ratio of the sensitive area does not match the aspect ratio of the array of radiation spots. Advantageously, unused portions of the sensitive area can be deactivated to increase the frame rate.

The spot generator preferably comprises a binary phase structure or an array of microlenses. The spot generator thus allows modulating an incident radiation beam to form the desired array of radiation spots at a desired distance from the spot generator.

The optical scanning device may be a microscope.

The optical scanning method according to the invention is characterized in that the angle γ between the scanning direction and the first lattice vector T₁ is at most as large as the angle between the scanning direction and the second lattice vector T₂, and the ratio L₁/L₂ is less than 0.6.

The method may comprise the additional step of generating an optical image of the array of radiation spots on a detector. Preferably the detector is a pixelated image sensor.

Preferably a portion of a sensitive area of the detector is deactivated. As stated above, the aspect ratio of the array of radiation spots is preferably substantially less than one. Yet standard image sensors have a rectangular sensitive area that is more or less quadratic, with aspects ratios not smaller than 3:4. Thus, when the array according to the invention is projected onto the image sensor, a substantial portion of the sensor's surface is superfluous. The frame rate of the sensor can then be substantially increased by deactivating the unused portion of the surface, that is, by reading out only the portion of the surface covered by the array of radiation spots.

### BRIEF DESCRIPTION OF THE DRAWINGS

FIG. 1 schematically illustrates a generic multispot scanning microscope.

FIG. 2 schematically illustrates an array of radiation spots of the prior art.

FIG. 3 schematically illustrates an array of radiation spots according to the invention.

FIG. 4 is a process chart of a method in accordance with the invention.

### DESCRIPTION OF PREFERRED EMBODIMENTS

In the drawings, similar or analogous features appearing in different figures are designated using the same reference numerals and are not necessarily described more than once.

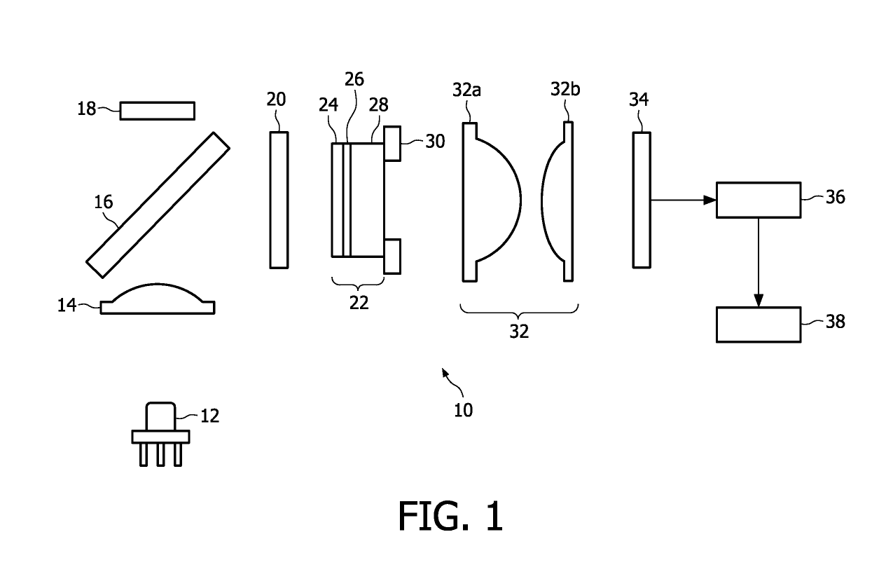

FIG. 1 schematically illustrates a generic prior art multispot scanning microscope. The microscope comprises a laser 12, a collimator lens 14, a beam splitter 16, a forward-sense photodetector 18, a spot generator 20, a sample assembly 22, a scan stage 30, imaging optics 32, a pixelated photodetector 34, a video processing integrated circuit (IC) 36, and a personal computer (PC) 38. The sample assembly 22 is composed of a cover slip 24, a sample layer 26, and a microscope slide 28. The sample assembly 22 is placed on the scan stage 30 coupled to an electric motor (not shown). The imaging optics 32 is composed of a first objective lens 32a and a second lens 32b for making the optical image. The objective lenses 32a and 32b may be composite objective lenses. The laser 12 emits a light beam that is collimated by the collimator lens 14 and incident on the beam splitter 16. The transmitted part of the beam is captured by the forward-sense photodetector 18 for measuring the light output of the laser 12. The results of this measurement are used by a laser driver (not shown) to control the output of the laser 12. The reflected part of the light beam is incident on the spot generator 20. The spot generator 20 modulates the incident light beam to produce an array of light spots in a sample placed in the sample layer 26. The imaging optics 32 generates on the pixelated photodetector 34 an optical image of the sample layer 26 illuminated by the array of scanning spots. The captured images are processed by the video processing IC 36 to a digital image that is displayed and possibly further processed by the PC 38. In view of cost, the photodetector 34 is preferably an off-the shelf image sensor. Advantageously, the total bandwidth of the image sensor 34 is utilized if the method of windowing is applied. In this method part of the rows (and/or columns) are shut down so that only the pixels within the “window” are read out. This gives an increase in frame-rate, and thus in throughput, equal to the ratio of the total sensor area and the window area.

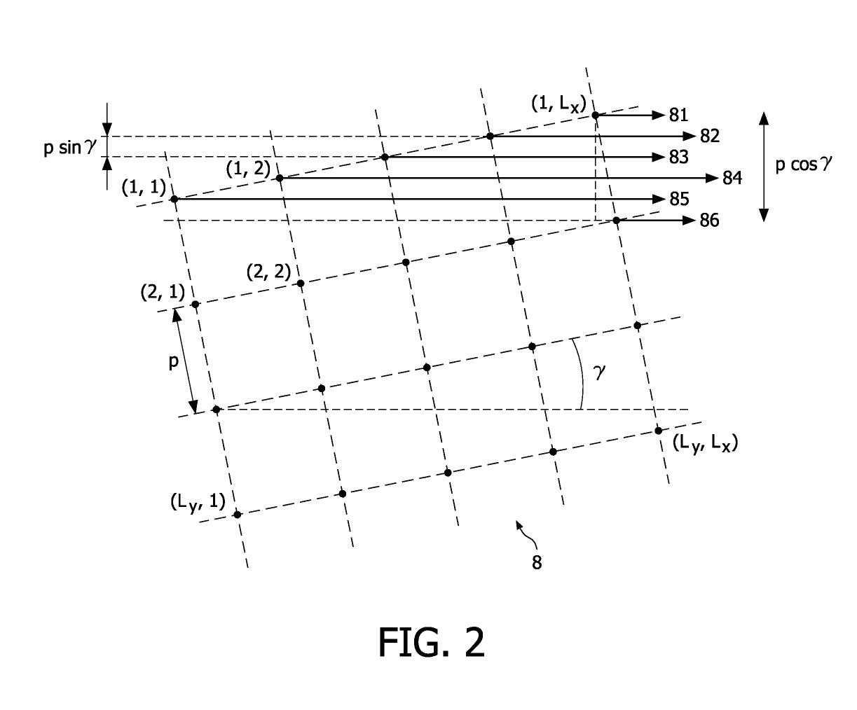

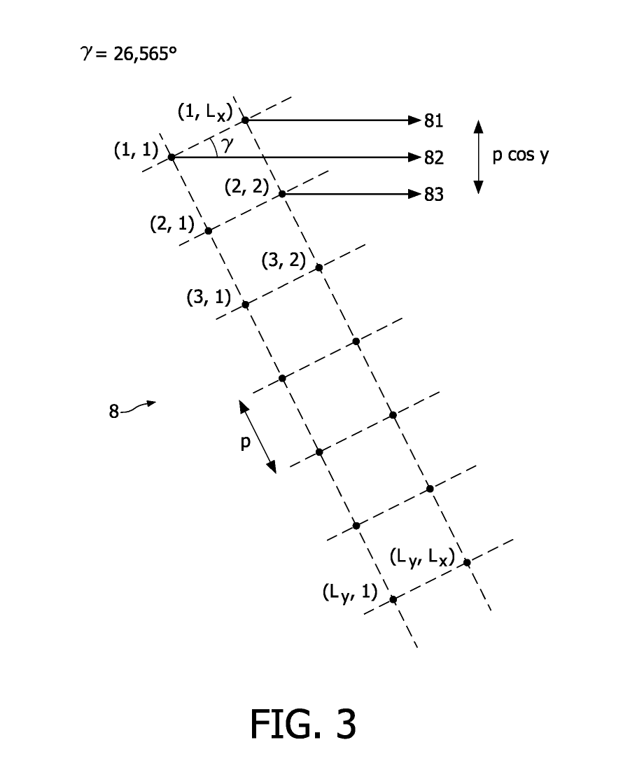

Referring to FIG. 2, there is shown schematically a two-dimensional array 8 of light spots generated in the sample layer 26 (see FIG. 3), in accordance with the prior art. The light spots form a two-dimensional lattice having square elementary cells of pitch p and unit cell area p². The array consists of Lₓ×L_{y} spots labelled (j, where i and j run respectively from 1 to Lₓ=5 and L_{y}=4. The lattice thus has an aspect ratio Lₓ/L_{y}=1.25. The two principal axes of the lattice are taken to be the x and the y direction, respectively. The array is scanned across the sample in a direction which makes a skew angle γ=arctan(1/Lₓ)=11.31° with the x direction. Each spot thus scans a line 81, 82, 83, 84, 85, 86 in the x-direction, the y-spacing between neighbouring lines being R/2 where R is the resolution and R/2 the sampling distance. The resolution is related to the angle γ by p sin γ=R/2 and p cos γ=LₓR/2. The width of the scanned “stripe” is w=LR/2. The throughput (in scanned area per time) is

$$B = \frac{1}{4} L {R}^{2} F$$

where F is the frame rate of the image sensor.

Referring now to FIG. 3, there is schematically shown an array 8 of radiation spots according to the invention. The array comprises Lₓ=2 columns and L_{y}=7 rows, giving it an aspect ratio Lₓ/L_{y}=0.286. The scanning angle γ is arctan(1/Lₓ)=26.565°. The parameter β=2D/R, where D is the length of the diagonal of the array 8, measures β=10\sqrt{2}=\sqrt{2}(1+Lₓ²)Lₓ. For this particular value of β and a given frame rate of the image sensor 34, the throughput B therefore is maximum (cf. Appendix B).

Another exemplary embodiment (not shown) uses a 28×142 spot array, so 3976 spots and an aspect ratio 0.20. The resolution is 0.51 μm, the pitch 7.20 μm, and the field of view is 1.04 mm (which fits a 20× objective on the imaging side). The accuracy in aligning the skew angle must be better than 1.3 mrad, which is feasible. The image sensor can have 1024×1280 pixels (1.3 Mpix, aspect ratio 4:5) with a nominal frame-rate of 500 Hz. By the use of windowing the frame-rate can be increased with a factor of 4. The throughput follows as 0.53 mm²/sec, which allows for imaging a histo-pathology slide with typical relevant area of 15 mm×15 mm in about 7 minutes.

A further increase in throughput may be achieved by using non-square spot arrays, in particular in using a hexagonal spot array. Generally, the array can be characterized by the lateral position of the spots of the array being given by Rₙₘ=np₁E₁+mp₂E₂, where n and m are integers labelling the spots, E₁ and E₂ are independent unit-vectors in the plane of the array, and p₁ and p₂ are the pitches in the direction of E₁ and E₂. The pitches must be larger than the smallest allowed distance between any two spots. Closest packing of spots (and hence largest number of spots) is then obtained if p₁=p₂=p. Furthermore, the angle α between the unit vectors E₁ and E₂ must be larger than π/3=60° in order to maintain the minimum spot separation p. It turns out that the total number of spots in the array L is independent of α, and that the aspect ratio of the spot array is proportional to 1/sin α. It follows that the minimum aspect ratio is obtained for the hexagonal spot array (α=π/3). Using windowing in the readout of the image sensor can thus increase the throughput with a factor 1/sin(π/3)=2/√3=1.15 compared to the case of a square array, i.e. a 15% increase in throughput can be realized in this way.

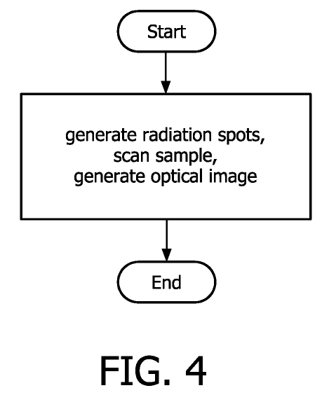

Referring to FIG. 4, there is shown a flow chart of a method according to the invention. The method comprises the simultaneous steps of generating an array of radiation spots, scanning a sample through the array, and generating an optical image on a pixelated image sensor.

While the invention has been illustrated and described in detail in the drawings and in the foregoing description, the drawings and the description are to be considered exemplary and not restrictive. The invention is not limited to the disclosed embodiments. Equivalents, combinations, and modifications not described above may also be realized without departing from the scope of the invention.

The verb “to comprise” and its derivatives do not exclude the presence of other steps or elements in the matter the “comprise” refers to. The indefinite article “a” or “an” does not exclude a plurality of the subjects the article refers to. It is also noted that a single unit may provide the functions of several means mentioned in the claims. The mere fact that certain features are recited in mutually different dependent claims does not indicate that a combination of these features cannot be used to advantage. Any reference signs in the claims should not be construed as limiting the scope.

### APPENDIX A

### Skew Angle Tolerance

The array of spots consists of Lₓ columns and L_{y} rows, and has a pitch p. The scan direction makes an angle γ with the rows, so that the set of spots generates a set of equidistant scan lines. The line spacing is R/2, with R the resolution. This scanning method implies that:

p sin γ=R/2

p cos γ=LₓR/2.

These relations are also given in U.S. Pat. No. 6,248,988. It follows that the number of spots in the x-direction is given by:

$${L}_{x} = cot γ = \sqrt{{( \frac{2 p}{R} )}^{2} - 1} .$$

In the case of a misalignment the angle γ (as defined in terms of resolution R, pitch p and number of columns Lₓ) may be have a different value γ′=γ+δγ. The question is how this will affect the image. Suppose we label the spots in the array with a pair of integers (i,j) labelling rows and columns, so i runs from 1 to L_{y} and j runs from 1 to Lₓ. Taking the origin of our (x,y) coordinate system at the lower left spot (L_{y},1) it follows that the x and y-position of spot (i,j) are given by:

xᵢⱼ=cos γ′(j−1)p−sin γ′(L_{y}−i)p

yᵢⱼ=sin γ′(j−1)p+cos γ′(L_{y}−i)p.

Expanding to first order in δγ and eliminating p and γ in favour of R and Lₓ gives that:

$${x}_{i j} = [ ( j - 1 ) {L}_{x} + i - {L}_{y} ] \frac{R}{2} - [ j - 1 + {L}_{x} ( {L}_{y} - i ) ] \frac{R}{2} δγ$$

$${y}_{i j} = [ j - 1 + {L}_{x} ( {L}_{y} - i ) ] \frac{R}{2} + [ ( j - 1 ) {L}_{x} + i - {L}_{y} ] \frac{R}{2} δγ$$

In the well aligned case δγ=0 the spots are located on equidistant scan lines, spaced by a distance R/2. We may label the scan lines with an integer index k=i−1+Lₓ(L_{y}−j), which takes values 1, 2, 3, . . . , LₓL_{y}. The y-value of scan line with index k is then simply (k−1)R/2. There is a delay between adjacent scan lines in the scan direction (the x-direction). The delay between scan lines that are both in the same row is Lₓ samples (the scanner takes samples spaced with R/2), the delay between the last scan line of a row and the first of the adjacent row is Lₓ(Lₓ−1)+1 samples.

In the misaligned case the different scan lines are no longer equidistant, and the delay of adjacent scan lines is no longer an integer amount of samples. This will result in a distorted image. The spacing between adjacent scan lines in the same row is now (1+Lₓδγ)R/2 and amounts to a uniform stretch in the y-direction, which is not too big of a problem, as it means that the resolution of the image is now slightly different, namely R′=(1+Lₓδγ)R. The spacing between the last scan line of a row and the first of the adjacent row is (1−(Lₓ(Lₓ−1)δγ)R/2≦(1−(Lₓ²+1)δγ)R′/2, which differs from the stretched resolution R′ by an amount (Lₓ²+1)δγR′/2. This must be much less than the nominal scan line spacing R/2, so we must require that:

$$δγ << \frac{1}{{L}_{x}^{2} + 1} = {sin}^{2} γ = {( \frac{R}{2 p} )}^{2}$$

It follows that a small Lₓ and hence a small ratio 2p/R is advantageous from the point of view of alignment. This condition is also sufficient to guarantee that the delay between adjacent scan lines is much less than the sampling distance R/2.

### APPENDIX B

### Throughput

In the following a lattice with square unit cell is considered. An analogous consideration applies for a lattice having a non-square unit cell, in particular a hexagonal unit cell.

The throughput B of the scanning device is defined as the scanned area per time. In the case of a two dimensional array,

$$B = \frac{1}{4} L {R}^{2} F$$

where R is the resolution, L=LₓL_{y} is the total number of radiation spots, and F is the frame rate. The lattice pitch p satisfies (see FIG. 2)

$${p}^{2} = \frac{{R}^{2}}{4} ( 1 + {L}_{x}^{2} ) .$$

The length D of the lattice diagonal satisfies

p²Lₓ²+p²L_{y}²=D²

which can be rewritten as

$$( 1 + {L}_{x}^{2} ) ( {L}_{x}^{2} + {L}_{y}^{2} ) = \frac{4 {D}^{2}}{{R}^{2}} = {β}^{2} .$$

The parameter

$$β = \frac{2 D}{R}$$

is assumed fixed. The number of rows L_{y} thus depends on the number of columns Lₓ according to

$${L}_{y}^{2} = \frac{{β}^{2}}{1 + {L}_{x}^{2}} - {L}_{x}^{2}$$

We thus obtain the following relation between the total number of points L and the number of columns Lₓ:

$${L}^{2} = {L}_{x}^{2} ( \frac{{β}^{2}}{1 + {L}_{x}^{2}} - {L}_{x}^{2} )$$

which may be expressed as

$$f ( q ) = \frac{{β}^{2} q}{1 + q} - {q}^{2}$$

where q=Lₓ² and f=L². The first and second derivatives of f with respect to q are

$${f}^{′} ( q ) = \frac{{β}^{2}}{{( 1 + q )}^{2}} - 2 q , \\ {f}^{″} ( q ) = - \frac{2 {β}^{2}}{{( 1 + q )}^{3}} - 2.$$

The first derivative f′ is seen to vanish for q=q₀, where q₀ satisfies

$$\frac{{β}^{2}}{2} = {{q}_{0} ( 1 + {q}_{0} )}^{2} .$$

Furthermore f″(q₀) is negative. Hence f (q) assumes a maximum for q=q₀. It is further noted that this is also the only maximum. It is concluded that for a given value of β and a given frame rate F, the throughput is maximum if Lₓ is the integer number that best satisfies

$$\frac{β}{\sqrt{2}} = {L}_{x} ( 1 + {L}_{x}^{2} ) .$$

In other words, in order to maximize the throughput under the constraint β=constant, Lₓ must differ from the real number Λ by less than 1, Λ satisfying

$$\frac{β}{\sqrt{2}} = Λ ( 1 + {Λ}^{2} ) .$$

It is mentioned that the same result can be established working with the independent variables Lₓ and L_{y} and taking into account the constraint (1+Lₓ²)(Lₓ²+L_{y}²)=β² by means of a Lagrange multiplier or by using the ratio x=2p/R or the aspect ratio as independent variable.

For any values of Lₓ and L_{y} the aspect ratio

$$μ = \frac{{L}_{x}}{{L}_{y}}$$

satisfies

$$\frac{1}{{μ}^{2}} = \frac{{β}^{2}}{q ( 1 + q )} - 1.$$

Inserting for q the optimum value q₀ determined above and using the identity β²=2q₀(1+q₀)² yields

$$\frac{1}{{μ}_{0}^{2}} = 1 + 2 {q}_{0}$$

where μ₀ is the aspect ratio for q=q₀, that is, μ₀ is the optimum aspect ratio. Since q₀≧1, the optimum aspect ratio satisfies

$${μ}_{0} \leq \sqrt{\frac{1}{3}} \approx 0.577 .$$

The optimum pitch p₀, that is, the pitch

$$p = \frac{{R}^{2}}{4} ( 1 + q ) for q = {q}_{0} ,$$

is found to satisfy

$${p}_{0}^{2} = \frac{{D}^{2}}{2 {q}_{0} ( 1 + {q}_{0} )} \leq \frac{{D}^{2}}{4} .$$

In the case of a lattice having a non-square unit cell, in particular a hexagonal unit cell, an analogous relation holds, with the left-hand side replaced by the area of the unit cell.

It is also possible to establish a direct relation between the number of spots and the aspect ratio. Eliminating Lₓ from the equations above gives

$$L = \frac{β}{\sqrt{{μ}^{2} + 1}} \sqrt{\frac{- 1 + \sqrt{1 + \frac{4 {β}^{2} {μ}^{2}}{{μ}^{2} + 1}}}{1 + \sqrt{1 + \frac{4 {β}^{2} {μ}^{2}}{{μ}^{2} + 1}}}} .$$

This function takes a maximum at the point defined by the analysis above. In practice the field of view is so large that several thousands of spots can be accommodated. This means that the parameter β is very large, typically in the range 1000-5000. For these values of β, the optimum aspect ratio is given to a good approximation by:

$${μ}_{0} = \frac{1}{{( 2 β )}^{1 / 3}} .$$

The error is less than 2% for β>10 and less than 0.1% for β>1000.

It is interesting to compare the optimum throughput B₀ (that is, the throughput for q=q₀) to the throughput B_{SQR} obtained with a square array having the same parameter β. Substituting L_{y}=Lₓ in the identity (1+Lₓ²)(Lₓ²+L_{y}²)=β² and solving for Lₓ² gives

$${L}_{x}^{2} = \sqrt{\frac{{β}^{2}}{2} + \frac{1}{4}} - \frac{1}{2} .$$

For large values of β, that is, for β>>1, and assuming that the same frame rate F is the same for the optimum array and the square array one obtains:

$$\frac{{B}_{0}}{{B}_{SQR}} = \frac{{L}_{0}}{{L}_{SQR}} = \frac{\sqrt{f ( {q}_{0} )}}{\sqrt{\frac{{β}^{2}}{2} + \frac{1}{4}} - \frac{1}{2}} \approx \frac{β}{\sqrt{\frac{{β}^{2}}{2}}} = \sqrt{2} .$$

For large values of β the throughput is thus increased by a factor of approximately 1.4 with respect to a square array.

Next the case is examined in which the photosensor is adapted to the array of radiation spots such that its frame rate F is inversely proportional to the area of the array:

$$F ∼ \frac{1}{{p}^{2} L}$$

In this case the throughput

$$B = \frac{1}{4} L {R}^{2} F$$

is inversely proportional to the area of the lattice unit cell, that is:

$$B ∼ \frac{1}{{p}^{2}} = \frac{4}{{R}^{2} ( 1 + {L}_{x}^{2} )}$$

The throughput then increases as Lₓ decreases and has a minimum for Lₓ=1.

1. An optical scanning device (10) comprising
a spot generator (20) for generating a two-dimensional array (8) of radiation spots at lattice points
Pₘₙ=mT₁+nT₂ (m=1 to L₁, n=1 to L₂)
where T₁ is a first lattice vector and T₂ is a second lattice vector;
scanning means for scanning a sample (26) through the array of radiation spots in a scanning direction such that the radiation spots trace essentially equidistant lines (81, 82, 83) relative to the sample;
wherein the angle γ between the scanning direction and the first lattice vector T₁ is at most as large as the angle between the scanning direction and the second lattice vector T₂, and the ratio L₁/L₂ is less than 0.6.

2. The optical scanning device as claimed in claim 1, wherein the ratio L₁/L₂ is less than 0.4.

3. The optical scanning device as claimed in claim 1, wherein the ratio L₁/L₂ is less than 0.2.

4. The optical scanning device as claimed in claim 1, wherein L₁ is 2, 3, or 4.

5. The optical scanning device as claimed in claim 1, wherein the product L₁L₂ is maximum or the area of the lattice unit cell is minimum, with a tolerance of 10%, under the constraint that the shape of the unit cell, the resolution, and the length of a lattice diagonal are fixed.

6. The optical scanning device as claimed in claim 1, wherein the unit cell of the lattice is a square or a hexagon.

7. The optical scanning device as claimed in claim 1, wherein L₁ differs from Λ by less then 1.0 or L₁ equals Λ with a tolerance of 10%, Λ being defined by
\sqrt{2}D/R=(1+Λ²)Λ,
D being the length of a lattice diagonal and R being the resolution.

8. The optical scanning device as claimed in claim 1, further comprising
a detector (34) and
imaging optics (32) for generating an optical image of the array of radiation spots on the detector.

9. The optical scanning device as claimed in claim 8, wherein the detector has an essentially circular field of view and the image of a lattice diagonal measures between 0.9 and 1.0 times the diameter of the field of view of the detector.

10. The optical scanning device as claimed in claim 8, wherein the detector has a sensitive area having an aspect ratio between 3:4 and 4:3.

11. The optical scanning device as claimed in claim 1, wherein the spot generator comprises a binary phase structure or an array of microlenses.

12. The optical scanning device as claimed in claim 1, wherein the optical scanning device is a microscope.

13. An optical scanning method comprising the steps of
generating a two-dimensional array (8) of radiation spots at lattice points
Pₘₙ=mT₁+nT₂ (m=1 to L₁, n=1 to L₂)
where T₁ is a first lattice vector and T₂ is a second lattice vector;
scanning a sample (26) through the array of radiation spots in a scanning direction such that the radiation spots trace essentially equidistant lines (81, 82, 83) relative to the sample;
wherein the angle γ between the scanning direction and the first lattice vector T₁ is at most as large as the angle between the scanning direction and the second lattice vector T₂, and the ratio L₁/L₂ is less than 0.6.

14. The optical scanning method as claimed in claim 13, wherein the method comprises the additional step of
generating an optical image of the array of radiation spots on a detector (34).

15. The optical scanning method as claimed in claim 13, wherein a portion of a sensitive area of the detector is deactivated.
